(19) United States
(12) Patent Application Publication
(10) Pub. No.: US 2006/0288747 A1
(43) Pub. Date: Dec. 28, 2006

(54) Motor vehicle with central locking

(76) Inventor: Heiko Bald, Modautal (DE)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 10/568,720

(22) PCT Filed: Mar. 9, 2005
(86) PCT No.: PCT/EP05/02485

§ 371 Date: Feb. 16, 2006

(30) Foreign Application Priority Data
Mar. 10, 2004 (DE) 102004011715.2

(51) Int. Cl. E05B 65/36

(52) U.S. Cl. 70/264

(57) ABSTRACT

A vehicle comprises a central locking system for at least vehicle doors, with which system an electrical switch for changing the central locking system over to a locking or an unlocking state is associated, and an opening lever, which is pivotably disposed at an inside at least of one vehicle door, for opening thereof. The switch is associated with the opening lever inside the vehicle door such that, when the opening lever is pivoted out of an inoperative position into a first switched position, it effects a locking or an unlocking state of the central locking system, and the locking or unlocking state is maintained until the opening lever is again pivoted into its switched position.

### TECHNICAL FIELD

The invention relates to a vehicle with a central locking system for at least vehicle doors, with which system an electrical switch for changing the central locking system over to a locking or an unlocking state is associated, and an opening lever, which is pivotably disposed at an inside at least of one vehicle door, for opening thereof.

### BACKGROUND OF THE INVENTION

DE 35 23 432 C1 discloses a central locking system with multiposition operation for locks, which can be operated by means of pneumatic or hydraulic actuating elements, on a vehicle, in particular for the driver's and front passenger's door, as well as the rear doors. The central locking system comprises a closing cylinder, which can be operated by a key, at least at the driver's and front passenger's door. The closing cylinders are actively connected to the actuating elements and electrical two-way switches. The operation of the closing cylinder by the key gives rise to a switching signal for triggering all the door locks into their locking or unlocking position by central assisted operation. The central locking system also comprises a vehicle operation switch which is formed as an ignition switch, and upon the manual operation of which into the closed position, all the door locks are changed over to their locking position. The door locks can be unlocked after the switch has been operated into the open position. The central locking system also comprises a closing pushbutton in the passenger compartment for arbitrarily locking and unlocking the central locking system and therefore all the door locks. Starting from the switched position of the ignition switch and the consequent central locking of all the door locks, the arbitrary, manual depression of the pushbutton into its closed position gives rise to a switching signal for central unlocking. A switching signal for the central locking of all the door locks is produced following the release of the pushbutton. However, a switching signal for the central unlocking of the central locking system is also delivered by means of the internal door operating handle of the door locks by closing a door contact switch. A switching signal for the central locking of all the doors by the central locking system is produced after the door has been closed and the door contact switch consequently opened. A switching signal for the central unlocking of all the door locks is produced by the reversing change-over switch following the operation of the ignition switch into its open position when the driver's or front passenger's door is opened by means of the internal door operating handle.

This central locking system has disadvantages in so far as the pushbutton must always be held in the depressed state in order to unlock the door locks. Moreover, the pushbutton, as an additional component, is in most cases disposed at a location in the passenger compartment, for example in a central control panel or in a control panel which is positioned in the vehicle door, which cannot be easily reached by the driver or, in particular, the front passenger, so that the operation and retention of the pushbutton results in the person carrying out the operation adopting an awkward posture.

EP 0 634 548 B1 presents a locking system for a door with a locking mechanism which can be locked or unlocked in order to prevent the door from being opened or enable it to be opened, and a locking cylinder which is connected by means of a first rod to the locking mechanism and can be operated from the outside of the door. The locking system also comprises a locking button which is connected by means of a second rod to the locking mechanism and can be operated from the inside of the door between a locking position and an unlocked position of the locking mechanism. The locking system further comprises a safety mechanism which can be electrically or electromagnetically operated in order to lock the locking button in its locking position or in order to unlock the locking button.

### SUMMARY OF THE INVENTION

The object of the invention is to provide a vehicle with a central locking system of the type initially mentioned which, using simple means, enables the vehicle doors to be arbitrarily locked or unlocked from the passenger compartment of the vehicle.

The object is solved according to the invention in that the switch is associated with the opening lever inside the vehicle door such that, when the opening lever is pivoted out of an inoperative position into a first switched position, it effects a locking or an unlocking state of the central locking system, and the locking or unlocking state is maintained until the opening lever is again pivoted into its switched position.

These measures provide a vehicle in which there is no switch for operating the central locking system in a central control panel or in a switch control panel disposed in the vehicle door. If the opening lever is moved out of the inoperative position into the first switched position, the switch generates a signal which causes the central locking system to lock or unlock the vehicle doors, according to the locking state. The central locking system usually causes the vehicle doors and optionally further closure flaps of the vehicle to be locked or unlocked by electronic means by acting upon corresponding actuating elements. Moreover, locked vehicle doors can be opened more reliably, as it is simply necessary to operate the opening lever. It is also unnecessary for the user of the opening lever to change his or her comfortable posture adopted in a seat of the vehicle in order to lock or unlock the vehicle doors, so that handling becomes extremely convenient.

In order to generate the signal for triggering the central locking system, the opening lever is simply pivoted manually out of its inoperative position into the first switched position until the switch integrated into the mechanism of the opening lever is tripped. The user of the opening lever is made aware of the actuation of the switch in the usual way by touch and/or sound. When it is released, the opening lever returns to its inoperative position through conventional means, for example spring-actuated. The state into which the central locking system has been switched by the switch is maintained until the opening lever is again brought into the switched position.

In order that the vehicle door may be mechanically opened by means of the opening lever, even when the central locking system is set in its locked state, when pivoted out of the inoperative position into a mechanical opening position for the vehicle door, the opening lever preferably passes through a second switched position in which the switch generates a signal for unlocking the central locking system. This ensures that the vehicle door is unlocked by the central locking system immediately before mechanical opening takes place.

The switch is expediently associated in a rotationally rigid manner with a pivot pin of the opening lever in order to obtain a structurally simple assembly.

It is, of course, possible to provide a switch at the opening lever of each vehicle door. A plurality of switches are then connected together in a known manner, for example, by means of a central control unit, which is in any case associated with the central locking system, and can be connected to the central locking system such that, upon operating any desired opening lever, either all the vehicle doors or just the vehicle door with the actuated switch are/is locked or unlocked or mechanically opened.

The features which are mentioned above and are to be illustrated in the following can, of course, be used not just in the respective indicated combinations, but also in other combinations.

### BRIEF DESCRIPTION OF THE DRAWINGS

The invention is illustrated in detail in the following on the basis of an embodiment, referring to the accompanying drawings, in which:

FIG. 1 is a schematic side view of an interior opening lever of a vehicle door of a vehicle according to the invention and

FIG. 2 is a plan view onto the representation according to FIG. 1.

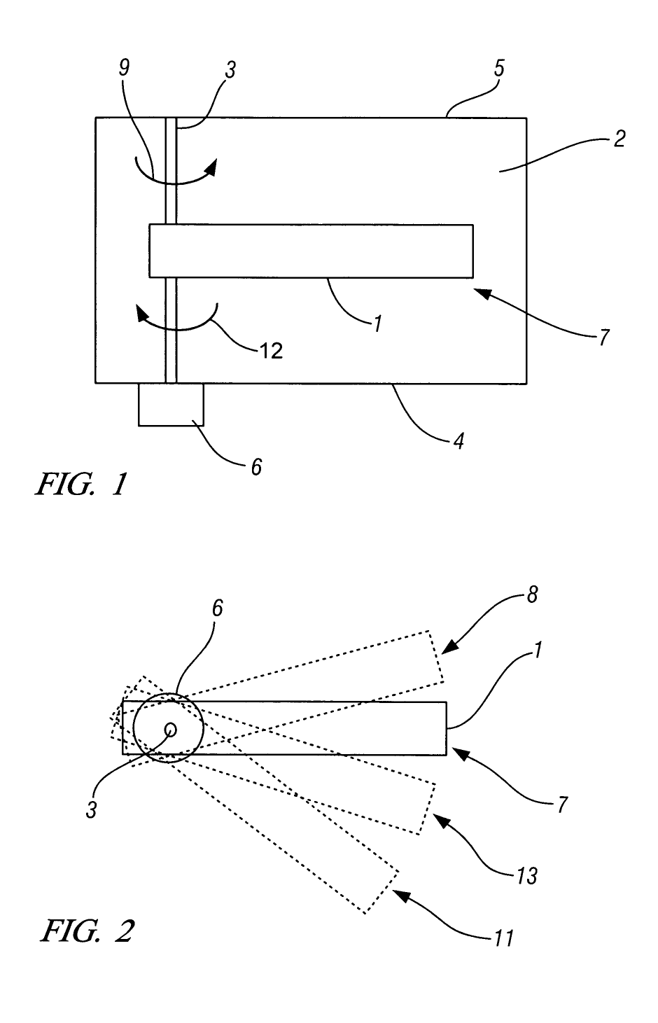

### DESCRIPTION OF THE PREFERRED EMBODIMENT

The opening lever 1 is disposed in a handle recess 2 at an inside of a vehicle door for mechanically unlocking the latter and is mounted on the vehicle door in a known manner by means of a firmly connected pivot pin 3. The pivot pin 3 extends perpendicularly from an underside 4 of the handle recess 2 to a top side 5 of the handle recess 2. A switch 6, which is secured to the underside 4 of the handle recess 2, is associated with the pivot pin 3 in a rotationally rigid manner. The switch 6 is electrically connected to a central locking system. The switch 6 can, of course, be provided at any vehicle door. In the represented embodiment, the switch 6 is associated with a driver's door of the vehicle, so that only the operation of this door is described in the following.

The switch 6 is coupled to the pivot pin 3 of the opening lever 1 such that it causes the vehicle door to be locked or unlocked when the opening lever 1 is moved out of an inoperative position 7 into a first switched position 8, in which the switch 6 generates a signal for locking or unlocking the central locking system and therefore the vehicle door, the opening lever 1 automatically returning from the first switched position 8 to its inoperative position 7 when released, and a locking or unlocking state of the central locking system being maintained until the opening lever 1 is again pivoted into the first switched position 8 (FIG. 2).

In order to reach the first switched position 8, in which the central locking system is locked or unlocked, according to the previous state of the central locking system, the opening lever 1 is pushed manually toward the outside of the driver's door, into the handle recess 2. In order to enter the vehicle, the vehicle doors are first unlocked by means of the central locking system, whereupon the driver's door can be opened with an operating element disposed at its outside. Once the driver has entered, the driver's door is closed and is in the unlocked state. If the driver now wishes to lock the driver's door or all the doors of the vehicle, the driver only has to move the opening lever 1 into the first switched position 8 by pushing the opening lever 1 towards the outside of the driver's door. As a result, the pivot pin 3 is rotated in the direction of the arrow 9 and the switch 6 accordingly actuated. A signal which causes the central locking system to lock the driver's door is therefore generated by the switch 6. After the opening lever 1 has been released, it returns, in particular in spring-actuated fashion, to its inoperative position 7, i.e., a neutral position, and the locking state is maintained. If the opening lever 1 is again pivoted into the first switched position 8, a signal is again generated, this signal causing the central locking system to unlock the driver's door. It is therefore possible, by operating the opening lever 1, to lock or unlock the driver's door or the vehicle doors, as desired at the time, by means of the central locking system.

A further function of the opening lever 1 is to mechanically open the driver's door. For this purpose, the opening lever 1 is shifted from the inoperative position 7 into an opening position 11 which is reached by pivoting the opening lever 1 in the direction of the passenger compartment. The pivot pin 3 is in the process rotated in the direction of the arrow 12. In order for the driver's door, which may be in a state in which it is locked by the central locking system, to be firstly unlocked by the central locking system, when the opening lever 1 is changed over from the inoperative position 7 to the opening position 11, it passes through a second switched position 13 of the switch 6 (FIG. 2), in which the switch 6 generates a signal which causes the central locking system to unlock the driver's door. This takes place before the opening position 11 is reached. The mechanical opening of the driver's door then comes into play when the opening position 11 is reached.

1. A vehicle with a central locking system for at least vehicle doors, with which system an electrical switch for changing the central locking system over to a locking or an unlocking state is associated, and an opening lever, which is pivotably disposed at an inside at least of one vehicle door, for opening thereof, wherein the switch is associated with the opening lever inside the vehicle door such that, when the opening lever is pivoted out of an inoperative position into a first switched position, it effects a locking or an unlocking state of the central locking system, and the locking or unlocking state is maintained until the opening lever is again pivoted into its switched position.

2. The vehicle according to claim 1, wherein, when pivoted out of the inoperative position into a mechanical opening position for the vehicle door, the opening lever passes through a second switched position in which the switch generates a signal for changing the central locking system over to the unlocking state.

3. The vehicle according to claim 1, wherein the switch is integrated into a mechanism of the opening lever.

4. The vehicle according to claim 2, wherein the switch is integrated into a mechanism of the opening lever.

5. The vehicle according to claim 1, wherein the switch is associated in a rotationally rigid manner with a pivot pin of the opening lever.

6. The vehicle according to claim 2, wherein the switch is associated in a rotationally rigid manner with a pivot pin of the opening lever.

7. The vehicle according to claim 3, wherein the switch is associated in a rotationally rigid manner with a pivot pin of the opening lever.

8. The vehicle according to claim 4, wherein the switch is associated in a rotationally rigid manner with a pivot pin of the opening lever.

9. The vehicle according to claim 1, wherein the opening lever automatically returns from its switched position and the opening position to its inoperative position.

10. The vehicle according to claim 2, wherein the opening lever automatically returns from its switched position and the opening position to its inoperative position.

11. The vehicle according to claim 3, wherein the opening lever automatically returns from its switched position and the opening position to its inoperative position.

12. The vehicle according to claim 4, wherein the opening lever automatically returns from its switched position and the opening position to its inoperative position.

13. The vehicle according to claim 5, wherein the opening lever automatically returns from its switched position and the opening position to its inoperative position.

14. The vehicle according to claim 6, wherein the opening lever automatically returns from its switched position and the opening position to its inoperative position.

15. The vehicle according to claim 7, wherein the opening lever automatically returns from its switched position and the opening position to its inoperative position.

16. The vehicle according to claim 8, wherein the opening lever automatically returns from its switched position and the opening position to its inoperative position.

17. The vehicle according to claim 9, wherein the opening lever returns in spring-loaded fashion to the inoperative position.

18. The vehicle according to claim 10, wherein the opening lever returns in spring-loaded fashion to the inoperative position.

19. The vehicle according to claim 11, wherein the opening lever returns in spring-loaded fashion to the inoperative position.

20. The vehicle according to claim 12, wherein the opening lever returns in spring-loaded fashion to the inoperative position.
